(19) United States
(12) Patent Application Publication
(10) Pub. No.: US 2015/0252916 A1
(43) Pub. Date: Sep. 10, 2015

(54) Lateral Sway Brace

(71) Applicant: Cooper Technologies Company, Houston, TX (US)

(72) Inventors: Richard W. Heath, Houston, TX (US); Dallas Martin Dworak, JR., Houston, TX (US)

(73) Assignee: Cooper Technologies Company, Houston, TX (US)

(21) Appl. No.: 14/197,112

(22) Filed: Mar. 4, 2014

(51) Int. Cl. F16L 3/133; E04B 1/38; F16L 3/08

(52) U.S. Cl. CPC F16L 3/133; F16L 3/08; E04B 1/38

(57) ABSTRACT

A lateral sway brace for a service pipe is disclosed. The lateral sway brace can include a pipe cradle portion configured to interface with a service pipe, the pipe cradle portion being supportable by a brace member coupled to a building support. The lateral sway brace can also include a securing portion configured to secure the service pipe to the pipe cradle portion. The pipe cradle portion can position the service pipe such that a longitudinal axis of the brace member supporting the service pipe intersects or is tangent to the service pipe.

### BACKGROUND

There is a multitude of products in the market utilized for bracing and supporting pipes, ducts, sprinkler systems, or other types of service pipes from ceilings, walls, beams or other structures. These products include clamps, braces, hooks, straps, plates, brackets, among other items. There are various types of braces or brace members, for example, pipes, channels and angle irons, with pipes being the most commonly used. Typically, one end of a bracing member, such as a bracing pipe, is secured to a ceiling, a wall, a beam or other structure. The other end of the bracing pipe is attached to the service pipe utilizing, for example, a clamp or a bracket or a brace securing the service pipe to a side of the bracing pipe, and therefore about the structure.

The manner of this connection between the service pipe and the bracing pipe and the components used can dictate the load-carrying capacity of the brace, as well as influence the time and labor expended in installing the brace.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIGS. 1 and 2 are example illustrations of a lateral sway brace system, in accordance with an embodiment of the present invention.

FIGS. 3 and 4 are example illustrations of a lateral sway brace of the system of FIGS. 1 and 2.

FIGS. 5A-6 are example illustrations of a lateral sway brace, in accordance with another embodiment of the present invention.

FIGS. 7A and 7B are example illustrations of securing members, in accordance with two embodiments of the present invention.

FIGS. 8A-9 are example illustrations of a lateral sway brace, in accordance with yet another embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although some brace configurations can provide adequate load capacity, they do so at the expense of burdensome load capacity analysis and wasteful use of excess material.

Accordingly, a lateral sway brace is disclosed for bracing a service pipe that can position the service pipe and the brace member such that a longitudinal axis of the brace member intersects or is tangent to the service pipe, which can simplify load capacity calculations and reduce material used by being subject to reduced stress compared to typical or prior related configurations. The lateral sway brace can include a pipe cradle portion configured to interface with a service pipe, the pipe cradle portion being supportable, either directly or indirectly, by a brace member coupled to a building support. The lateral sway brace can also include a securing portion configured to secure the service pipe to the pipe cradle portion. The pipe cradle portion can position the service pipe such that a longitudinal axis of the brace member supporting the service pipe intersects or is tangent to the service pipe.

In one aspect, a lateral sway brace system for bracing a service pipe is disclosed. The system can comprise a service pipe and a brace member coupled to a building support. The system can also comprise a lateral sway brace, as described herein.

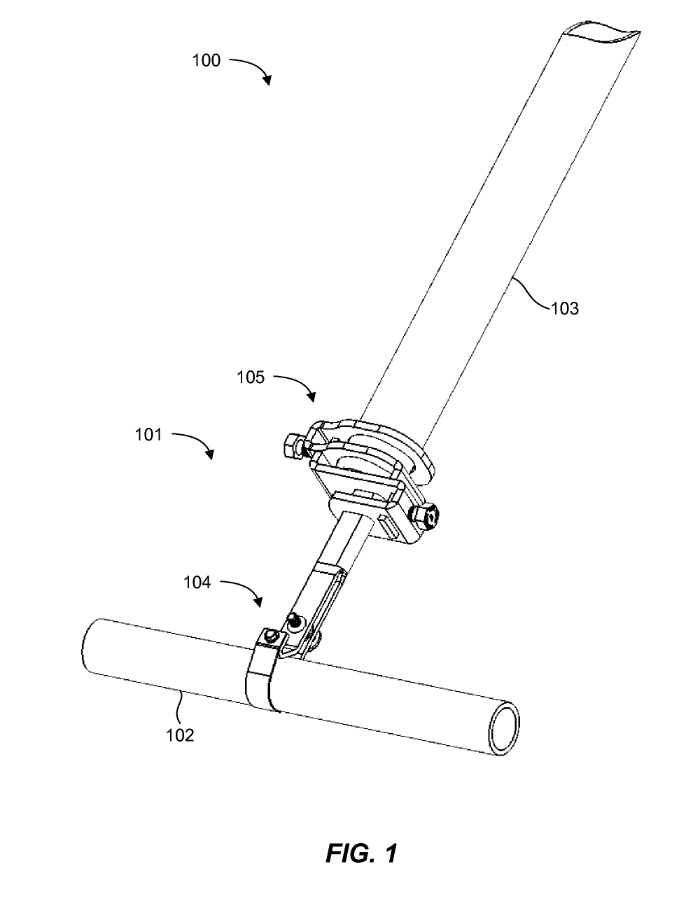

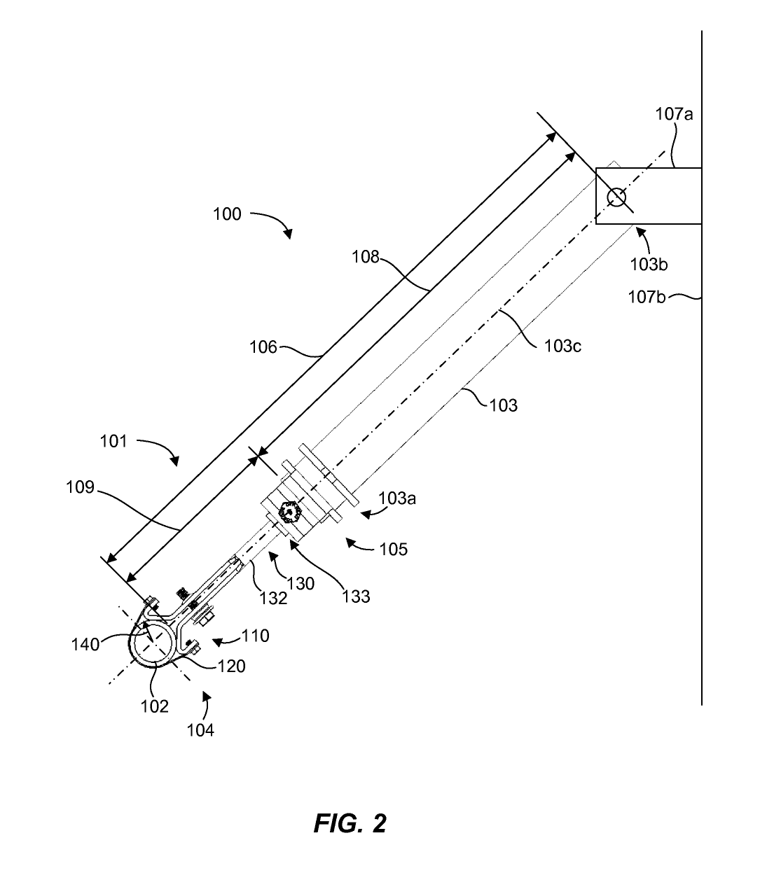

One embodiment of a lateral sway brace system 100 is illustrated in FIGS. 1 and 2. In general, the lateral sway brace system 100 can comprise a lateral sway brace 101, a service pipe 102, and a brace member 103. The service pipe 102 can be any service pipe found in a building, such as a water pipe, a drain pipe, etc. and can therefore be constructed of any suitable material, such as a polymer or a metal.

The brace member 103 can be any structural member suitable of providing support to the service pipe 102 for a given loading condition, such as seismic loading. Accordingly, the brace member 103 can comprise, for example, a pipe, a strut, a rod, a beam, a bar, or combinations thereof. These are not meant to be limiting in any way as other types of brace members may be known to those skilled in the art.

The lateral sway brace 101 can include a pipe coupler 104 securable to the service pipe 102 and a brace coupler 105 securable to the brace member 103 to couple the service pipe 102 to the brace member 103, and to cause the service pipe 102 to be supported about a building or other structure. Exemplary types of lateral sway braces and associated brace couplers are described in U.S. application Ser. No. ______, filed ______, and entitled “Lateral Sway Brace” (attorney docket no. 3210-003), which application is incorporated by reference in its entirety herein. In one aspect, the brace coupler 105 and the pipe coupler 104 can be operable with the brace member 103 to laterally support the service pipe 102 from a building support 107a, 107b. The building support can include a coupling device or mounting bracket 107a for the brace member 103 to a wall 107b, ceiling, beam, or any other structural feature of a building capable of providing support to the service pipe 102. In some embodiments, a building support can include the wall 107b, ceiling, beam, or other structural feature of a building.

With particular reference to FIG. 2, the pipe coupler 104 of the lateral sway brace 101 can include a pipe cradle portion 110 configured to interface with the service pipe 102. The pipe cradle portion 110 can be supported, directly or indirectly, by the brace member 103 coupled to the building support 107a, 107b. The brace coupler 105 and the pipe coupler 104, such as the pipe cradle portion 110, can be operable with the brace member 103 to laterally support the service pipe 102 from the building support 107a, 107b. The pipe coupler 104 of the lateral sway brace 101 can also include a securing portion 120 configured to facilitate securing of the service pipe 102 to the pipe cradle portion 110. In one aspect, the pipe cradle portion 110 can position the service pipe 102 such that a longitudinal axis 103c of the brace member 103 intersects or is tangent to the service pipe 102, which can simplify load capacity calculations and reduce material used by being subject to reduced stress compared to typical arrangements. In one aspect, the pipe coupler 104, and particularly the pipe cradle 110, can be configured to facilitate a moment arm due to loading on the pipe from the brace member 103 having a length that is less than a radius 140 of the service pipe 102.

In addition, the lateral sway brace 101 can include a length adjustment mechanism 130 operable with the brace coupler 105 and having a variable length to extend between the service pipe 102 and the brace member 103 to accommodate a gap or distance 109 between an end of the brace member 103 and the service pipe 102. Adjustability can therefore be achieved within the lateral sway brace 101, namely between the pipe coupler 104 and the brace coupler 105, to accommodate variable gaps caused by different sized brace members 103. In one aspect, the length 108 of the brace member 103 can vary to a certain degree from what may be an ideal or exact length, such as between about 1 inch to about 12 inches in a non-limiting example, with the sway brace 101 being able to adjust and account for or absorb such differences and maintain a proper or desired distance 106 of the service pipe 102 from the building support 107a, 107b. In a particular aspect, a length adjustment of the lateral sway brace 101 can be used to tune and fine tune adjustment once the length 108 of the brace member 103 is within and acceptable range of adjustability of lateral sway brace 101. One potential benefit of the adjustable length of the sway brace 101 is reduced time and effort for installation because the length 108 of the brace member 103 need not be precise. As will be apparent from the present disclosure, the installation time can also be reduced due to the ease and simplicity of installing the lateral sway brace and adjusting an effective length of the sway brace to accommodate or match the gap 109 between the brace member 103 and the service pipe 102.

The brace coupler 105 can be configured to secure or couple the length adjustment mechanism 130 to the brace member 103. In one embodiment, the length adjustment mechanism 130 can be securable to an end 103a of the brace member 103 proximate the service pipe 102.

In one aspect, the length adjustment mechanism 130 of the lateral sway brace 101 can include an extension member 132 and an extension member securing portion 133 operable to vary the effective length of the extension member in order to accommodate or match the difference between the predetermined distance 109 between the service pipe 102 and the brace member 103. The extension member 132 can be part of the pipe coupler 104 or the brace coupler 105, or it can be a separate component.

As discussed herein, a lateral sway brace in accordance with some embodiments of the present disclosure can eliminate, minimize or reduce stress due to an “overturning” moment or cantilever effects common with a typical brace configuration in which an outer surface of the brace member contacts and rests against an outer surface of the service pipe (i.e., an eccentrically loaded configuration). Accordingly, a sway brace of the present disclosure can provide for an increase in allowable load ratings over prior sway braces having eccentrically loaded configurations (assuming a brace member of the same type) and can comply with evolving building codes and standards. Furthermore, a sway brace of the present disclosure can reduce potential damage to the service pipe under similar loads experienced using a sway brace having an eccentric configuration. For example, an eccentric configuration would tend to induce undesirable rotation in the service pipe due to the eccentric manner of attachment. In addition, a sway brace in accordance with the present disclosure can facilitate a reduction in length of the brace member over a sway brace having an eccentric attachment configuration. This manner of sway brace loading disclosed herein can also provide benefits under certain loading conditions, such as seismic loading. For example, this can lead to a load path through the various components of the system 100 that primarily loads the service pipe 102 in tension and/or compression, while potentially reducing, minimizing or eliminating moment loading on the service pipe 102 (depending upon the load path through the service pipe). Such a condition can be beneficial for analyzing the system 100 under a given loading condition and can lead to a sway brace having less material, which can reduce costs.

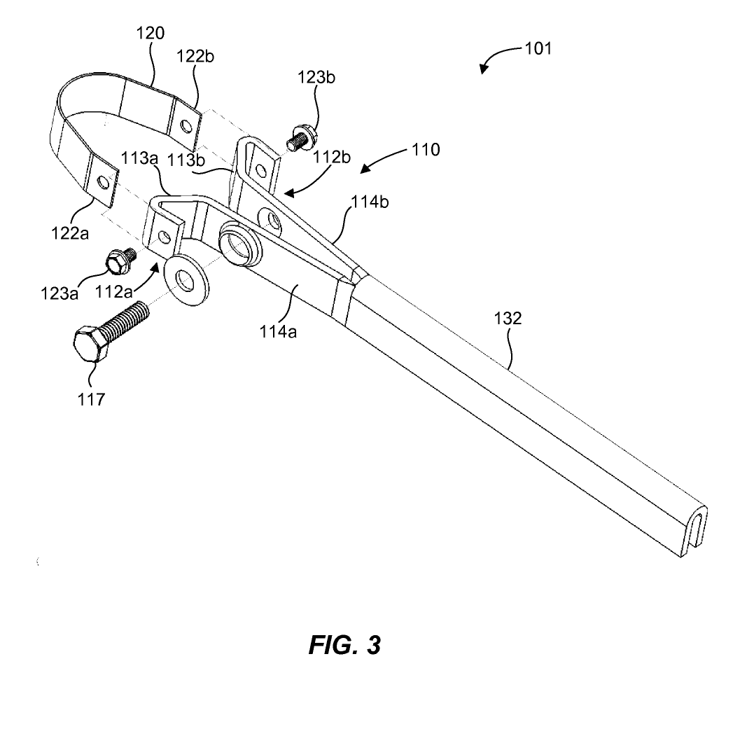

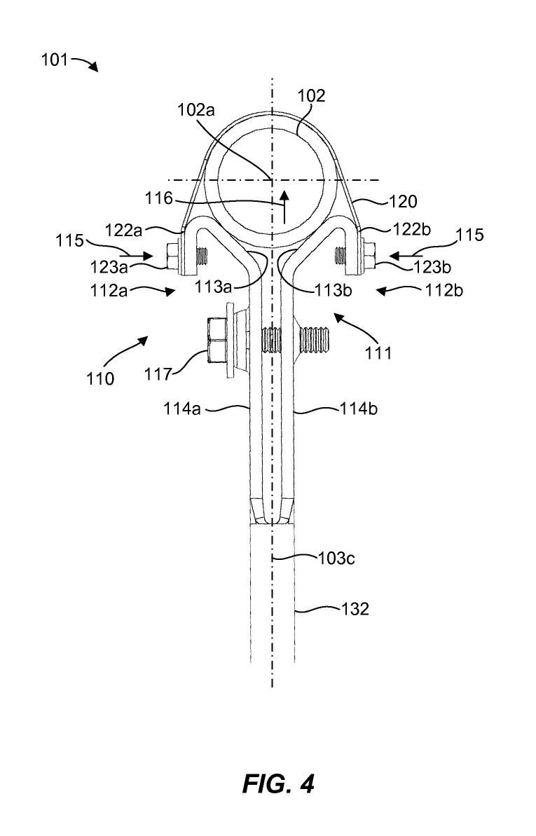

With reference to FIGS. 3 and 4, and continued reference to FIGS. 1 and 2, certain features of the lateral sway brace 101 are shown. For example, the pipe cradle portion 110 can comprise a V-channel 111 to interface with and receive the service pipe 102. The V-channel 111 can have sides 112a, 112b that provide contact surfaces 113a, 113b arranged in a V-shaped configuration to accommodate a variety of different sized service pipes 102 as well as function to automatically center the service pipe 102 in the center of the V-channel 111, which can facilitate proper alignment of the service pipe 102 relative to the brace member 103, as discussed herein. In one aspect, the V-channel 111 can be oriented such that the base of the V-channel 111 is substantially in-line with the longitudinal axis 103c of the brace member 103. In other words, the pipe cradle portion 110 can be configured to interface with a side of the service pipe 102 facing an end of the brace member 103, which can function to primarily load the service pipe 102 in tension and/or compression, while minimizing or eliminating moment loading on the service pipe 102. Although a V-channel with substantially flat contact surfaces 113a, 113b is illustrated, it should be recognized that a V-channel can comprise a curved contact surface or any other suitable configuration that provides a self-centering function for the support pipe 102.

The pipe cradle portion 110 can further comprise terminating ends that extend from the sides 112a, 112b of the V-channel 111, which can be configured to extend away from the service pipe 102, as shown. In some embodiments, the terminating ends can provide a support for receiving the securing portion 120 and securing this to the pipe cradle portion 110 as discussed herein.

As shown in the figures, the securing portion 120 can comprise a band or other member capable of extending about the service pipe 102 and attaching or otherwise securing to the pipe cradle portion 110 (e.g., a flexible band, a wire, a cable, etc.). The securing portion 120 can further comprise opposite ends 122a, 122b that can be coupleable or otherwise securable to the sides 112a, 112b of the V-channel 111 of the pipe cradle portion 110 (e.g., about terminating ends), such as with bolts 123a, 123b, a rivet, or other suitable coupling device or fastener. In one aspect, the sides 112a, 112b of the V-channel 111 can be configured to move or displace relative to one another (e.g., flex, bend, pivot, etc. depending upon their configuration) to facilitate securing the service pipe 102 to the pipe cradle portion 110. For example, the pipe cradle portion 110 can include extension arms 114a, 114b coupled to, formed integrally with, or otherwise in support of the sides 112a, 112b of the V-channel 111, respectively.

The extension arms 114a, 114b can extend outward from and can displace relative to a base portion. In one exemplary embodiment, the pipe cradle portion 110 can be formed of the same piece of material having bends therein as shown to define the base portion, extension arms 114a, 114b and the V-channel 111 (including the terminating ends).

Relative movement of the extension arms 114a, 114b in direction 115 can therefore be operable to cause the sides 112a, 112b of the V-channel 111 to move relative to one another, which can cause the service pipe 102 to move in direction 116 as the service pipe rides up the surfaces 113a, 113b of the V-channel 111. In one aspect, a bolt 117 can be operable with the extension arms 114a, 114b to locate the extension arms 114a, 114b and the sides 112a, 112b relative to one another, and to facilitate movement of the sides 112a, 112b of the V-channel 111 relative to one another.

Thus, as shown in FIG. 4, to secure the service pipe 102 to the lateral sway brace 101, the service pipe 102 can be disposed in the V-channel 111, the securing portion 120 can be caused to extend about the service pipe 102 and the ends 122a, 122b coupled to the sides of the V-channel 111 (about the terminating ends), and the bolt 117 can be tightened to cause the extension arms 114a, 114b to move toward one another, causing the service pipe 102 to slide up the contact surfaces 113a, 113b of the V-channel 111 and into a more forceful contact relationship with the securing portion 120 until a sufficient preload on the service pipe 102 or compression has been reached. As shown, the pipe cradle portion 110 can position the service pipe 102 such that a longitudinal axis 103c of the brace member 103 intersects, as in this case, or is tangent to the service pipe 102. In this particular embodiment, the longitudinal axis 103c of the brace member 103 intersects a longitudinal axis 102a of the service pipe 102. Thus configured, the securing portion 120 can be subjected only to simple tensile loading that the securing portion 120 can withstand without requiring a robust design or makeup. More complex loads, such as moments and lateral forces that can cause bending of the securing portion 120, are minimized in this configuration.

In one aspect, the extension arms 114a, 114b can be coupled to or otherwise supported about the extension member 132 of the length adjustment mechanism 130 of the lateral sway brace 101. Alternatively, the lateral sway brace 101 can comprise an extension member separate from any adjustment mechanism, which extension member can be in support of the pipe cradle portion 110 and configured to extend between the pipe coupler 104 and the brace member 103 (or a brace coupler (e.g., brace coupler 105 of FIG. 1)) to facilitate coupling the pipe coupler 104 to the brace member 103. The extension member 132 can comprise a pipe, a strut, a rod, a beam, a bar, or combinations thereof.

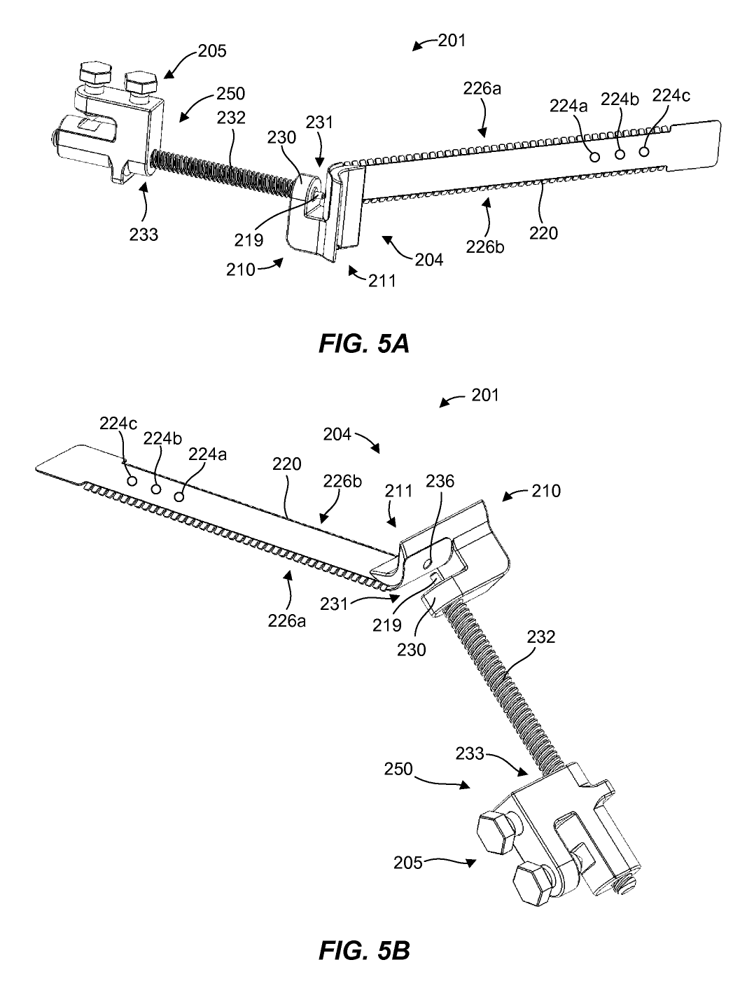

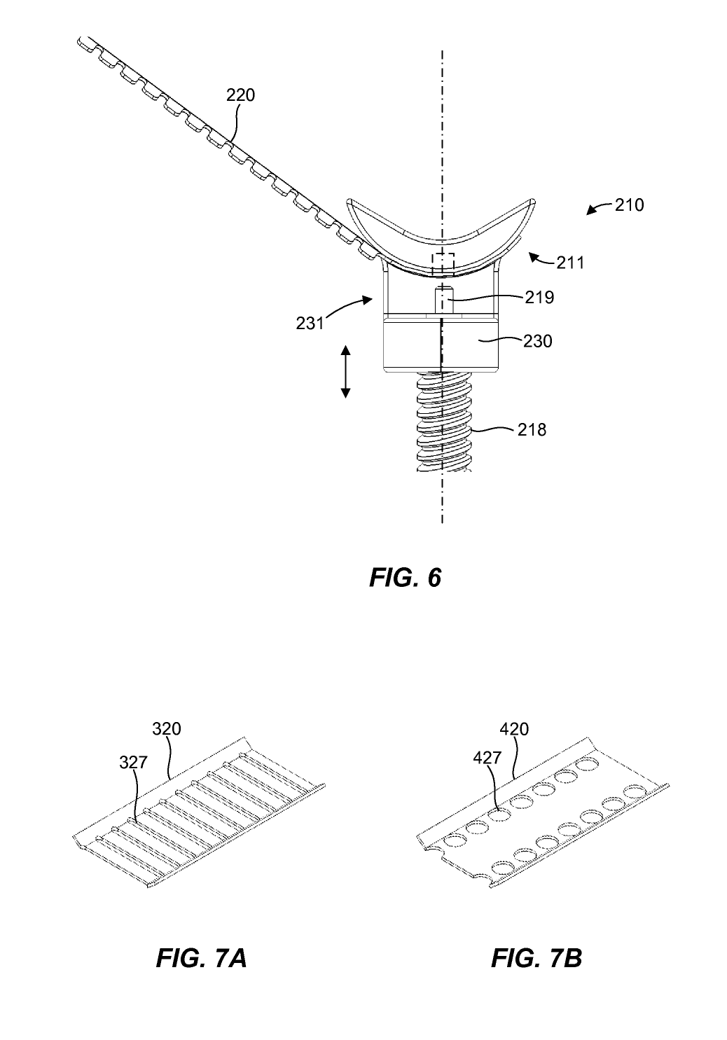

FIGS. 5A-6 illustrate another exemplary embodiment of a lateral sway brace 201, in accordance with the present disclosure. As with other lateral sway braces disclosed herein, the lateral sway brace 201 can include a pipe coupler 204 having a pipe cradle portion 210 and a securing portion 220. The lateral sway brace 201 can further comprise a brace coupler 205 and an extension member 232 extending between the pipe coupler 204 and the brace coupler 205, which extension member 232 may be part of or be operable with an adjustment mechanism to allow the pipe coupler 204 (and the service pipe) to vary in length or distance from the brace coupler 205 and a brace pipe. It will be apparent that the lateral sway brace 201 can, in general, include similar components and/or elements that can have similar attributes as other lateral sway braces disclosed herein.

In this embodiment, the pipe coupler 204 can comprise a pipe cradle portion 210 and a securing portion 220, as shown. The securing portion 220 can comprise a flexible member attachable to the pipe cradle portion 210 and configured to wrap around a service pipe and extend to an underside of a V-channel 211 of the pipe cradle portion 210. A first end of the securing portion 220 can be coupled or attached to the pipe cradle portion 210, with the other end being free to be manipulated about the service pipe and subsequently coupled or secured to the pipe cradle portion 210. The securing portion 220 can secure a service pipe to the pipe cradle portion 210 by utilizing a hole formed in the securing portion (e.g., see holes 224a, 224b, 224c, each of which can correspond to a suitable coupling location on the securing portion 210 for a different size of service pipe). The securing portion 220 can be formed of a thin metal, polymer, composite or other suitable material that can be bent or wrapped around a service pipe and that has sufficient strength to secure the service pipe to the pipe cradle portion 210 under operating load conditions for the service pipe, such as seismic loading. In one aspect, the securing portion 220 can have flared edges 226a, 226b to prevent the securing portion 220 from digging into or otherwise damaging a plastic service pipe.

In one aspect, the pipe cradle portion 210 can comprise an L-shaped arm 230 extending down from the V-channel 211. The arm 230 can comprise a threaded portion configured to receive a threaded portion of an extension member 218. The arm 230 can at least partially define or form a channel 231 between the arm 230 and an underside of the V-channel 211, wherein the channel 231 is configured to receive and to facilitate access to the underside of the V-channel 211 by the securing portion 220 when wrapped around a service pipe. An end 219 of the extension member 218 can comprise a reduced cross-sectional area portion configured to engage the securing portion 220 to couple the securing portion and a service pipe to the pipe cradle portion 210. In one aspect, the end 219 of the extension member 218 can be inserted through a pre-existing opening (such as one of holes 224a, 224b, 224c) formed in the securing portion 220. In another aspect, the end 219 can be configured to puncture the securing member 220 to form an opening or hole in the securing member 220 upon securing a service pipe to the pipe cradle portion 210, wherein the securing portion 220 is formed of suitable material. The end 220 of the extension member 218 can further be configured to engage the V-channel 211. In one aspect, the end 220 of the extension member 218 can be configured to extend into or be received within a hole 236 formed in an underside of the V-channel 211 to securely couple the securing member 220 to the underside of the V-channel 211 and to the pipe cradle portion 210.

Thus, to secure a service pipe to the sway brace 201, the service pipe can be disposed or seated in the V-channel 211. With one end secured to the pipe cradle portion 210, the securing portion 220 can be wrapped around the service pipe and the other end coupled to an underside of the V-channel 111 by threading the extension member 218 into the arm 230 until the end 218 of the extension member 218 has penetrated the securing member 220, such as by passing into an existing hole 224a, 224b, 224c, or forming a hole, and has been caused to be inserted into the hole 236 in the pipe cradle portion 210. In one aspect, a given hole 224a, 224b, 224c can provide a suitable preload and compression for a given size service pipe when secured.

In addition, the lateral sway brace 201 can include a length adjustment mechanism 250 operable with the brace coupler 205 and having a variable length to extend between a service pipe and a brace member to accommodate a gap or distance between an end of the brace member and the service pipe. Adjustability can therefore be achieved within the lateral sway brace 201, namely between the pipe coupler 204 and the brace coupler 205, to accommodate variable gaps caused by different sized brace members. The brace coupler 205 can be configured to secure or couple the length adjustment mechanism 250 to a brace member, such as an end of a brace member proximate a service pipe. In one aspect, the length adjustment mechanism 250 can include an extension member 232 and an extension member securing portion 233 operable to vary the effective length of the extension member in order to accommodate or match a distance or gap between a service pipe and a brace member. The extension member 232 can be part of the pipe coupler 204 or the brace coupler 205, or it can be a separate component.

FIGS. 7A and 7B and illustrate additional embodiments of securing members. In this case, the securing members 320, 420 are configured to enhance flexibility for wrapping around a service pipe, as in the embodiment illustrated in FIGS. 5A-6. For example, the securing member 320 of FIG. 7A comprises lateral slots 327 and the securing member 420 of FIG. 7B comprises laterally disposed circular holes to provide enhanced flexibility for the securing members 320, 420 when wrapping around a service pipe.

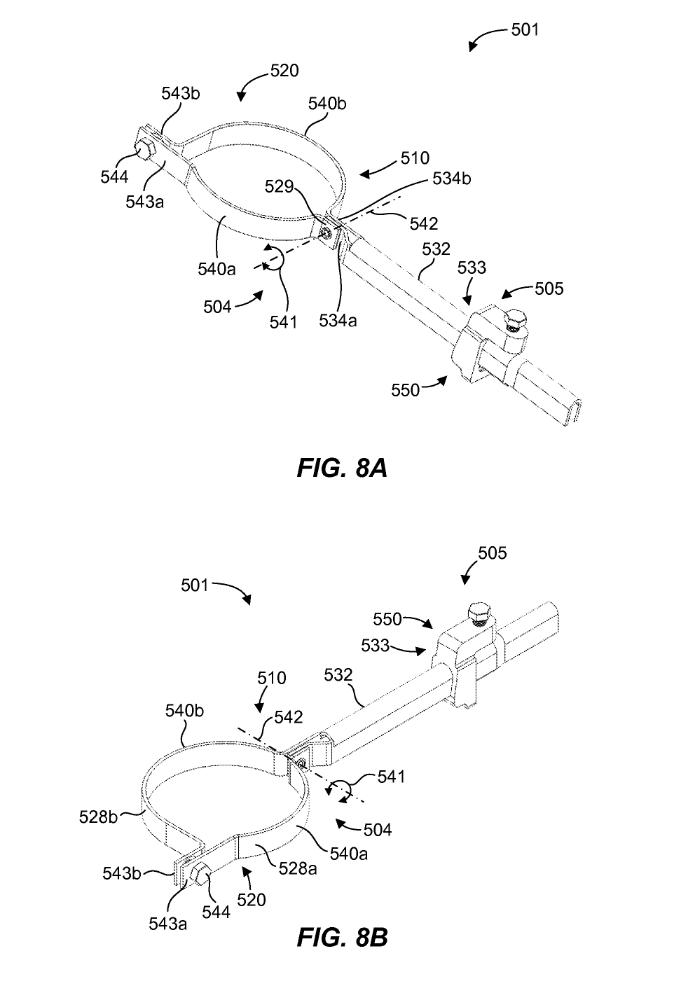

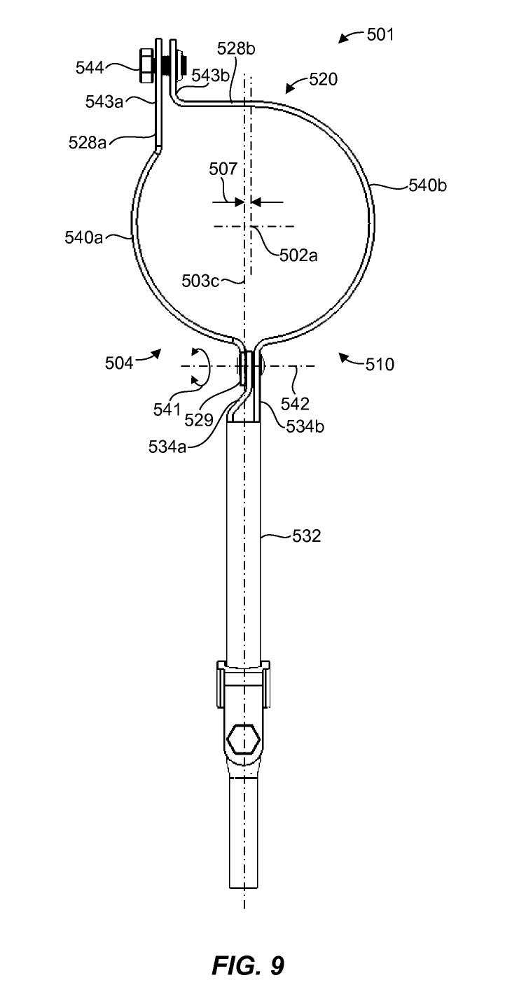

FIGS. 8A-9 illustrate another embodiment of a lateral sway brace 501, in accordance with the present disclosure. As with other lateral sway braces disclosed herein, the lateral sway brace 501 can include a pipe coupler 504 having a pipe cradle portion 510 and a securing portion 520. The lateral sway brace 501 can further comprise a brace coupler 505 and an extension member 532 extending between the pipe coupler 504 and the brace coupler 505, which extension member 532 may be part of or be operable with an adjustment mechanism to allow the pipe coupler 504 (and the service pipe) to vary in length or distance from the brace coupler 505 and a brace pipe. It will be apparent that the lateral sway brace 501 can, in general, include similar components and/or elements that can have similar attributes as other lateral sway braces disclosed herein.

In this embodiment, the pipe cradle portion 510 can comprise a first member 540a and a second member 540b pivotally coupled to one another, such as about ends 534a, 534b of an extension member 532. The first member 540a can have an end 529 pivotally coupled to the end 534a of the extension member 532. In one aspect, the second member 540b can be fixed relative to the end 534b of the extension member 532, such as by having of a unitary construction with one another. In another aspect, the second member 540b can be rotatable relative to the end 534b of the extension member 532.

The first and second members 540a, 540b can be configured to be rotatable relative to one another in opposing directions 541 about axis 542 to facilitate opening of the pipe cradle portion 510 and to provide access to the pipe cradle portion 510 by a service pipe, or in other words, to facilitate securing of the pipe cradle portion 510 to the service pipe to brace the service pipe. The first and second members 540a, 540b can have extensions 528a, 528b, which can position ends 543a, 543b of the first and second members 540a, 540b for coupling to one another, such as by a fastener 544, to the secure a service pipe to the pipe cradle portion 510. In this particular aspect, the pipe coupler 504 can comprise a securing portion 520 formed or comprised of the first and second members 540a, 540b. The first and second members 540a, 540b can be configured to have a size and curvature corresponding to a service pipe size, such that coupling ends 543a, 543b of the first and second members 540a, 540b will result in a suitable preload or compression about the service pipe as provided by the pipe coupler 504. In one aspect, the first and second members 540a, 540b can be asymmetric about a longitudinal axis 503c. For example, the first member 540a can have a shallower curve than the second member 540b. This can facilitate pivoting the first member 540a about the axis 540, without excessive interference with a service pipe disposed in the curve of the second member 540b, in order to secure the service pipe. The extensions 528a, 528b of the first and second members 540a, 540b can position the ends 543a, 543b of the first and second members 540a, 540b for coupling to one another at a location offset from the axis 503c.

Thus, to secure a service pipe to the sway brace 501, the first member 540a can be rotated relative to the second member 540b about the axis 542 to provide a suitable access path or opening to allow the service pipe to be received or disposed in the pipe cradle portion 510. The first member 540a can then be rotated about the axis 542 to facilitate coupling of the end 543a of the first member 540a with the end 543b of the second member 540b with the fastener 544. This coupling arrangement can be configured to provide a clamping force about the service pipe, thereby providing a suitable preload and compression for the service pipe when secured.

In addition, the lateral sway brace 501 can include a length adjustment mechanism 550 operable with the brace coupler 505 and having a variable length to extend between a service pipe and a brace member to accommodate a gap or distance between an end of the brace member and the service pipe. Adjustability can therefore be achieved within the lateral sway brace 501, namely between the pipe coupler 504 and the brace coupler 505, to accommodate variable gaps caused by different sized brace members. The brace coupler 505 can be configured to secure or couple the length adjustment mechanism 550 to a brace member, such as an end of a brace member proximate a service pipe. In one aspect, the length adjustment mechanism 550 can include an extension member 532 and an extension member securing portion 533 operable to vary the effective length of the extension member in order to accommodate or match a distance or gap between a service pipe and a brace member. The extension member 532 can be part of the pipe coupler 504 or the brace coupler 505, or it can be a separate component.

With particular reference to FIG. 9, a longitudinal axis 503c of a brace member (not shown, but see brace member 103 of FIGS. 1 and 2) is shown offset a distance 507 from an axis 502a of a service pipe (not shown, but see service pipe 102 of FIGS. 1 and 2). This is not meant to be limiting in any way as the sway brace can be configured so that axes 503c and 502a are not offset, but intersect. Although offset, the longitudinal axis 503c of the brace pipe can still be configured to intersect or to be tangent to the service pipe as secured within the pipe coupler 504, as with other sway braces discussed herein. Thus configured, the securing portion 520 can be subjected primarily to simple tensile loading as also discussed herein. Indeed, more complex loads, such as moments and lateral forces that can cause bending of the securing portion 120, can be greatly reduced in this configuration.

In accordance with one embodiment of the present invention, a method of facilitating bracing of a service pipe is disclosed. The method can comprise providing a pipe coupler having a pipe cradle portion configured to interface with a service pipe, the pipe cradle portion being supportable by a brace member coupled to a building support. The method can further comprise providing a securing portion configured to secure the service pipe to the pipe cradle portion. Additionally, the method can comprise facilitating positioning of the service pipe, such that a longitudinal axis of the brace member supporting the service pipe intersects or is tangent to the service pipe. As with other methods disclosed herein, no specific order is required in this method, though generally in one embodiment, these method steps can be carried out sequentially.

In one aspect of the method, the longitudinal axis of the brace member intersects a longitudinal axis of the service pipe. In another aspect of the method, facilitating positioning of the service pipe comprises providing the pipe cradle portion with a V-channel to interface with the service pipe.

The method can further comprise adjusting the length of the pipe coupler relative to the brace member using an adjustment mechanism operable with a brace coupler.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A lateral sway brace for a service pipe, comprising:
a pipe coupler having a pipe cradle portion configured to interface with a service pipe, the pipe cradle portion being supportable by a brace member coupled to a building support, and a securing portion configured to secure the service pipe to the pipe cradle portion,
wherein the pipe cradle portion positions the service pipe such that a longitudinal axis of the brace member supporting the service pipe intersects or is tangent to the service pipe.

2. The lateral sway brace of claim 1, further comprising:
a brace coupler operable to couple with the brace member, wherein the brace coupler and the pipe coupler are operable with the brace member to laterally support the service pipe from the building support, and wherein the brace member has a length less than a predetermined distance between the service pipe and the building support; and
a length adjustment mechanism operable with the brace coupler and having a variable length to accommodate a difference between the predetermined distance between the service pipe and the building support and the length of the brace member.

3. The lateral sway brace of claim 1, wherein the longitudinal axis of the brace member intersects a longitudinal axis of the service pipe.

4. The lateral sway brace of claim 1, wherein the pipe cradle portion comprises a V-channel to interface with the service pipe.

5. The lateral sway brace of claim 4, wherein first and second sides of the V-channel are configured to move relative to one another to facilitate securing the service pipe to the pipe cradle portion.

6. The lateral sway brace of claim 5, wherein opposite ends of the securing portion are coupleable to the first and second sides of the V-channel.

7. The lateral sway brace of claim 5, wherein the pipe cradle portion further comprises first and second extension arms coupled to the first and second sides of the V-channel, respectively, wherein relative movement of the first and second extension arms is operable to cause the first and second sides of the V-channel to move relative to one another.

8. The lateral sway brace of claim 7, further comprising a bolt operable with the first and second extension arms to move the first and second sides of the V-channel relative to one another.

9. The lateral sway brace of claim 7, wherein the first and second extension arms are coupled to an extension member in support of the pipe cradle portion and extending between the pipe cradle portion and the brace member to facilitate coupling the pipe cradle portion to the brace member.

10. The lateral sway brace of claim 1, wherein the pipe cradle portion comprises a first member and a second member pivotally coupled to one another to facilitate access to the pipe cradle portion by the service pipe.

11. The lateral sway brace of claim 10, wherein the securing portion comprises the first and second members.

12. The lateral sway brace of claim 11, wherein ends of the first and second members are coupleable to one another to the secure the service pipe to the pipe cradle portion.

13. The lateral sway brace of claim 1, wherein the securing portion comprises a flexible member attached to the pipe cradle portion to wrap around and secure the service pipe to the pipe cradle portion.

14. The lateral sway brace of claim 1, further comprising an extension member in support of the pipe cradle portion and extending between the pipe cradle portion and the brace member to facilitate coupling the pipe cradle portion to the brace member.

15. The lateral sway brace of claim 14, wherein an end of the extension member is configured to penetrate an opening formed in the flexible band to secure the service pipe to the pipe cradle portion.

16. The lateral sway brace of claim 15, wherein the pipe cradle portion comprises a threaded portion to couple with a threaded portion of the extension member.

17. The lateral sway brace of claim 1, wherein the extension member comprises a pipe, a strut, a rod, a beam, a bar, or combinations thereof.

18. A lateral sway brace system for bracing a service pipe, comprising:
a service pipe;
a brace member coupled to a building support; and
a lateral sway brace for the service pipe, comprising:
a pipe cradle portion configured to interface with the service pipe, the pipe cradle portion being supportable by the brace member, and
a securing portion configured to secure the service pipe to the pipe cradle portion,
wherein the pipe cradle portion positions the service pipe such that a longitudinal axis of the brace member supporting the service pipe intersects or is tangent to the service pipe.

19. The system of claim 18, wherein the longitudinal axis of the brace member intersects a longitudinal axis of the service pipe.

20. The system of claim 18, wherein the pipe cradle portion comprises a V-channel to interface with the service pipe.

21. A method of facilitating bracing of a pipe, comprising:
providing a pipe cradle portion configured to interface with a service pipe, the pipe cradle portion being supportable by a brace member coupled to a building support;
providing a securing portion configured to secure the service pipe to the pipe cradle portion; and
facilitating positioning of the service pipe such that a longitudinal axis of the brace member supporting the service pipe intersects or is tangent to the service pipe.

22. The method of claim 21, wherein the longitudinal axis of the brace member intersects a longitudinal axis of the service pipe.

23. The method of claim 21, wherein facilitating positioning of the service pipe comprises providing the pipe cradle portion with a V-channel to interface with the service pipe.
